(19) United States
(12) Patent Application Publication
(10) Pub. No.: US 2016/0129960 A1
(43) Pub. Date: May 12, 2016

(54) BICYCLE THEFT MONITORING AND RECOVERY DEVICES

(71) Applicant: BIKETRAK, INC., Portland, OR (US)

(72) Inventors: Kristine Akins, Portland, OR (US); Montgomery Goodson, Portland, OR (US); Peter Skeggs, Portland, OR (US); Scott Rumbaugh, Portland, OR (US); Claire Zyla, Portland, OR (US)

(73) Assignee: BikeTrak, Inc.

(21) Appl. No.: 14/846,616

(22) Filed: Sep. 4, 2015

Related U.S. Application Data
(63) Continuation of application No. 13/712,831, filed on Dec. 12, 2012, now abandoned.
(60) Provisional application No. 61/569,764, filed on Dec. 12, 2011.

(51) Int. Cl. B62H 5/20; H04L 29/08; H04W 4/04; H04W 4/02

(52) U.S. Cl. CPC B62H 5/20; H04W 4/021; H04L 67/26; H04W 4/04

(57) ABSTRACT

Bicycle theft monitoring and recovery systems include a tracking device with geolocation capabilities that is mountable to or integrated into a bicycle or other asset. Communications between the tracking device and a networked server or a user device permit configuring the tracking device as well as receiving reports of asset disturbances. The server coordinates tracking devices and assets for a plurality of users. In some examples, a user mobile device is configured to display tracker status, disturbance reports, and asset location and initiate alarms in response to disturbance reports from the tracking device.

### CROSS REFERENCE TO RELATED APPLICATION

This application is a continuation of U.S. patent application Ser. No. 13/712,831, filed Dec. 12, 2012, which claims the benefit of U.S. Provisional Application 61/569,764, filed Dec. 12, 2011, both of which applications are incorporated by reference herein.

### FIELD

The disclosure pertains to bicycle anti-theft and tracking systems.

### BACKGROUND

Bicycles have long been a prime target for theft and stolen bicycles are rarely recovered. Bicycle usage often involves leaving bicycles for extended periods in public areas from which they may be quickly stolen if not properly secured, and often even when they are properly secured. Bicycling has long been a popular mode of transportation in many regions around the world, and has become a popular leisure activity, leading to adoption of numerous specialized and expensive bicycle frames and accessories, and thereby greatly increasing the impact of a stolen bicycle on the owner. The impact of a bicycle theft often extends beyond material value as avid cyclists often develop an emotional bond to their bicycle. Due to the high material and emotional value of bicycles, numerous bicycle locking devices have been developed. Even with these devices, bicycle thefts remain common. Unfortunately, adequate tracking devices suitable for aiding in the recovery of stolen bicycles are unavailable due to the unique and difficult demands that such devices must meet.

Tracking devices incorporating GPS and cellular capabilities are available for motorcycles, cars, pets, people, and other assets, but these devices are not suitable for bicycles. A bicycle does not offer convenient places to hide a tracker, such as a motorcycle or car does, requiring the tracker to be both small, and specifically designed for bicycle integration. Bicycles also do not usually have a readily accessible power source to tap into for long-term operation of a tracker. Trackers for pets and people typically have very short battery life, but this is not desirable for a device that is intended to be mounted on a bicycle and largely forgotten about until needed. Battery life of many months to a year is desirable by most bicyclists. Accordingly, practical tracking devices for bicycles continue to be needed.

### SUMMARY

Bicycle theft monitoring and recovery solutions described herein comprise a bicycle-mounted tracking device (“tracker”); apparatus for communicating between the tracker and a remote server; software (computer-executable instructions) executed at the server to manage multiple users, multiple trackers, states of the trackers, and actions performed on information from the trackers or on commands from the users; and user applications with which the user may be notified of state changes of the tracker and with which the user may respond to these state changes, remotely mange the trackers, and/or mange the user's account settings. Additionally, a wireless proximity key may be used by the user to automatically alter the tracker's armed state whenever the user moves in or out of wireless range of the tracker, or manually with a push-button on the key.

The user may interface with the tracker via a web application accessible from computers and/or web-enabled phones, from a native smart phone application, or via SMS from any cell phone. The user may be alerted within seconds of a possible theft event; may be able to locate the last reported location of the bicycle; may be able to alter tracker settings such as increasing the reporting frequency to assist with bicycle recovery, or reduce the frequency to save battery power until recovery is attempted; and may be able to report a bicycle theft directly to the appropriate authorities. A smart phone application may include additional features for bicycle recovery and can be configured to list and/or map all the reported stolen bicycles for a region, and provide tools for analyzing the theft data. The user may also be alerted via text messages, and the user can able to alter tracking settings and report a theft as discussed above via text messages. A tracker includes a unique identifier that can be readable from the outside of the tracker and may be used to contact a bicycle owner through a publically accessible internet service provided by the server, preferably though a web page.

Tracker power consumption can be managed to prolong battery life. If certain events such as motion or jostling are detected by an accelerometer, sensors and a microcontroller can be awakened from a sleep mode. Intrusion detection sensors can also trigger sensors and a microcontroller to exit sleep mode. The microcontroller qualifies events to verify that they match one of a multitude of user-configurable events of interest, and if the tracker is in an armed state, the microcontroller will then activate a satellite receiver to obtain a geolocation fix, and activate the cellular radio to report the event to the server and retrieve any state change commands or other commands from the server. Location may be determined using other methods including AGPS and cellular triangulation.

Arming and disarming the tracker may be accomplished by one or more methods. One method is based on an RF proximity key which is configured to automatically disarm the tracker whenever the key is within 1-2 meters of the tracker or other distance. The tracker may only query the presence of the key upon events of interest, and exchange encrypted unique identifiers with the key to verify authenticity. The key may use a number of standard protocols operating in the unlicensed ISM bands, such as Bluetooth Low Energy, ANT, Zigbee, RFID, or proprietary communication protocols. A plurality of keys may be paired with the tracker by the user, and the keys may take on the form of a key-fob, a clip-on tag attachable to the bicycle rider's clothing, equipment, or use hardware supporting the same protocol as the tracker that is already built into off-the-shelf smart phones, watches, heart-rate monitors, and other consumer devices. Pairing new keys with the tracker, or removing old keys, may be managed by the user via a user account on the server. The tracker may also be armed by pushing a physical button on the tracker, in which case the tracker enters an armed state immediately, or may be armed or disarmed by changing the armed state on the server, in which case the tracker retrieves the desired armed state the next time it communicates with the server. In other examples, a biometric sensor is coupled so as to arm or disarm the tracker. The desired armed state can be communicated from the server using arming and disarming commands and data communicated via a landline phone, cell phone, smart phone, table computer, desktop computer, laptop, or other processing devices.

Asset monitoring and recovery devices comprise a satellite receiver configured to receive satellite signals associated with asset location and a cellular transceiver configured for communication in a cellular network. At least one sensor is configured to detect an asset disturbance. A controller is coupled to the satellite receiver, the cellular transceiver, and the at least one sensor and configured to supply a message for communication by the cellular transceiver. The message is based on at least one of the asset disturbance and the received satellite signals. In some examples, the at least one sensor is configured to detect the asset disturbance as an asset vibration, displacement, tilt, or temperature. In some embodiments, the controller is configured to establish an asset event based on the asset disturbance, and the message includes an asset event report. In other examples, the asset event is established based on a motion profile, and the asset event report indicates an asset vibration or displacement. In typical examples, the message is a text message, an email, or a push notification. In further representative examples, a proximity key receiver is configured to detect a proximity key, wherein the proximity key receiver is coupled to the controller so as to produce a disarm signal if a proximity key is detected. An enclosure is configured to be secured to a bicycle frame, and comprises an antenna configured to be secured to the frame exterior. In some examples, the enclosure is configured to be situated within the bicycle frame. In a particular example, a water bottle rack secured to the enclosure.

Mobile communication devices comprise wireless transceivers configured to receive asset status information from a tagged asset. A display is configured to provide asset status, wherein the status includes an indicator of an availability of a current location, and an indicator of asset security. In some examples, the asset status information includes asset identification information as an asset photograph or serial number. In some examples, the asset is a bicycle. In other embodiments, the transceiver is configured to communicate a request to arm or disarm an asset tracker and to communicate asset tracker profile information associated with arming an asset tracker. In still additional examples, the asset tracker profile information includes an authorization to establish an armed asset tracker profile based on asset location, time of day, or asset disturbances. In other examples, the transceiver is configured to communicate an alarm request. In yet other embodiments, the transceiver is configured to receive notification of an asset disturbance or event, and the display is configured to indicate the asset disturbance or event. Typically, the transceiver is configured to receive the notification of the asset disturbance or event as a push notification or a text message, and to communicate a request to disarm the asset based on relative location of the mobile device and the asset. In further examples, a proximity key transceiver is configured to communicate a request to disarm the asset based on relative location of the mobile device and the asset.

Methods comprise evaluating asset displacements of a tracked asset within a predetermined time period, and, based on the evaluation, indicating that the asset displacements are associated with unauthorized asset access. A message indicating an unauthorized access is then communicated as a data message, a text message, or an email to a wireless cellular network. In other examples, a message is communicated associated with indicating an alarm at the tracked asset. In further examples, a request is communicated to notify law enforcement or a personal network, a social network, or a stolen bicycle registry of the unauthorized access.

The foregoing and other features and advantages of the disclosed technology will become more apparent from the following detailed description, which proceeds with reference to the accompanying figures.

### BRIEF DESCRIPTION OF THE DRAWINGS

FIGS. 1A-1B are schematic diagrams illustrating a representative bicycle tracker.

FIG. 2 is a block diagram of a representative proximity key for use with a tracker such as illustrated in FIGS. 1A-1B.

FIG. 3 illustrates cloud-based provisioning of bicycle tracking services such as bike location, theft reporting, and bike tracker initialization, activation, and control.

FIG. 4 illustrates a representative computing system configured as a bicycle tracking server.

FIG. 5 illustrate a representative mobile device configured to access trackers and tracking services.

FIGS. 6-11 are screenshots of mobile device displays illustrating configuration of tracker and tracking service setup, accounting, reporting, and other parameters.

FIGS. 12A-12B illustrate a representative water bottle mounting based tracker.

FIGS. 13A-13B illustrate a tracker that is enclosed in a housing that is integrated with a water bottle cage.

FIG. 14 illustrates a tracker provided in a bicycle seat bag.

FIG. 15 illustrates a seat-mounted bicycle tracker.

FIG. 16 illustrates a bicycle tracker situated within bicycle handlebars.

FIG. 17 illustrates a bicycle tracker situated in a bicycle seat post.

FIGS. 18A-18D illustrate accessory mounted trackers.

FIG. 19 illustrates bicycle fork and wheel mounted trackers.

FIG. 20 illustrates a representative computing environment.

FIG. 21 illustrates a representative method of configuring a tracker and reporting disturbances.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Tracking systems and methods are disclosed herein with reference to bicycle security but the same or similar systems and methods can be applied to other assets including but not limited to computers, guitars, solar panels, cars, skis, skateboards etc. The disclosed technology can aid in recovery of stolen bikes and other assets and tracking of legitimate users in order to, for example, locate children or to obtain crash alerts. Thefts can be readily reported, and bicycle data such as serial, color, components, photos can be stored or accessed for filing police reports or other uses such as submitting other notifications concerning a missing bicycle or compilation of data about bicycle usage for government, social, industry and manufacturing purposes to, among other things, improve bicycle safety, usage, reliability and user experience. Numerous other examples are described below with reference to representative implementations.

### Representative Tracking Devices (Trackers)

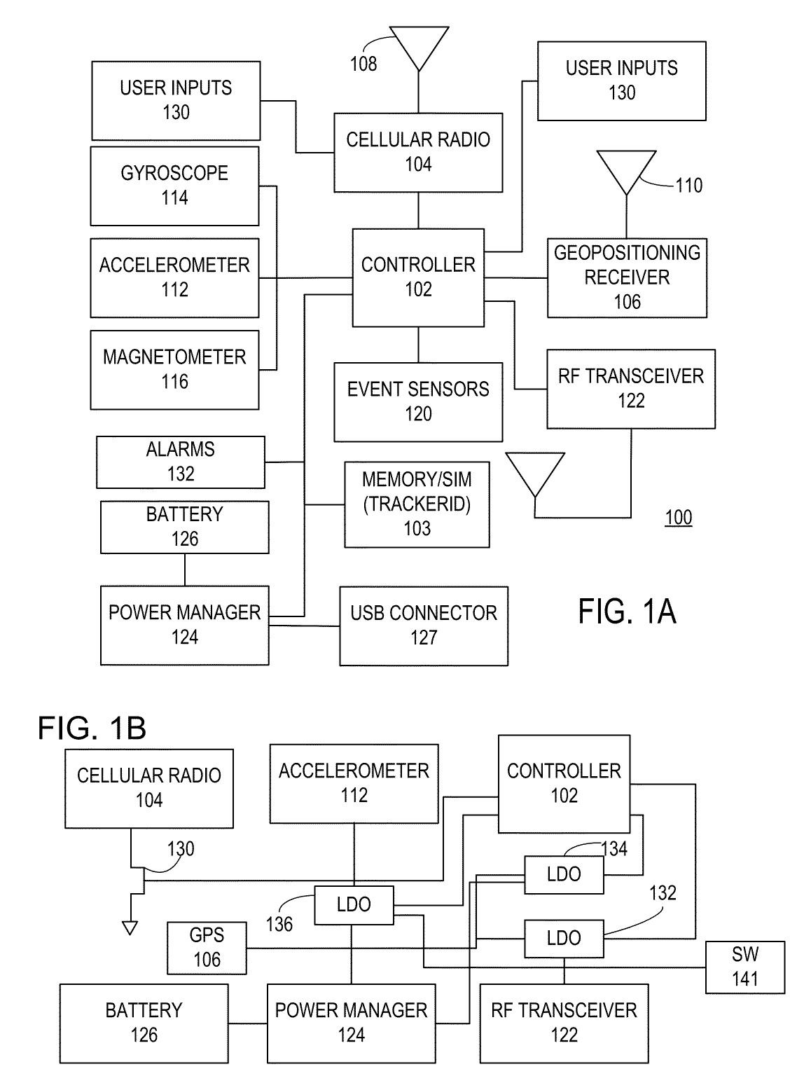

Referring to FIG. 1A, a representative bicycle tracker 100 includes a controller 102 such as a microprocessor that is in communication with a cellular radio 104 or a wireless network and a geopositioning receiver 106 that are coupled to respective antennas 108, 110. The cellular radio 104 is configured to communicate with a cellular network based on GSM, CDMA, or cellular network protocols. The cellular antenna 108 can be a multiband antenna, or two or more antennas configured for selected frequency bands can be used. The geopositioning receiver 106 and the antenna 110 are configured to receive signals for determining position based on, for example, triangulation using publically available signals from GPS, AGPS, GLONASS, Galileo, and/or COMPASS global navigation satellites. For convenience in assembly and repair, antenna connections can be made using suitable RF connectors, but these are not shown in FIG. 1A. Tracker position can also be estimated based on cellular triangulation and other cellular communication characteristics. Estimates can be determined by the controller 102 or at a cloud based server or other device.

A memory 103 is coupled to the controller 102 and configured to store computer-executable instructions for tracker operation. The memory 103 can be supplemented with a subscriber identity module (SIM) for use in establishing machine-to-machine communication with a cellular network. A unique tracker ID can also be stored in the memory 103 along with a SIM ID, an IMEI, IMSI, or other identifiers. The memory 103 can be configured to retain location data, event data or other information that is sent as it is acquired or is accumulated for transmission as a data batch.

Supplementary navigation sensors such as a 3-axis accelerometer 112, a 3-axis gyroscope 114, and a 3-axis magnetometer 116 are coupled to the controller 102 to provide additional signals that are processed by the controller to provide additional position/motion estimates, particularly if geopositioning signals are unavailable. The three-axis accelerometer 112 can also serve as an event sensor to detect disturbances such as vibrations of other movements of the tracker 100. Other event sensors such as an optical detector, camera, compass, altimeter, microphone, vibration sensor, biometric sensor, tilt sensor, temperature sensor, or mechanical switches are provided and produce signals that are coupled to the controller 102 for detecting motion, other disruptive events such as tampering with a bicycle or the tracker. A transceiver 122 such as an ISM band radio-frequency (RF) transceiver is coupled to the controller 102 as well. The transceiver 122 is configured to communicate with or detect an RF proximity or other proximity key such as an RFID tagged key, and based on the communication, the controller 102 can set a status of the tracking device to “armed” or “disarmed,” and/or initiate a communication via the cellular radio 104 so as to notify the bicycle owner of a current event. In other examples, the transceiver 122 can be based on radio-frequency communication, low frequency communication, communication standards such as wireless network standards, BLUETOOTH communications, audio or ultrasonic communication, or visible, infra-red or other optical communication as convenient. In typical examples, responsive to detection of a proximity key, the controller 102 issues appropriate “disarm” instructions. If an absence of a recently present proximity key is detected, the controller 102 can set the tracker 100 to be in an armed state.

User control of arming and disarming can also be provided with a USB connector 127 (or other suitable physical connector) into which a user USB device can be inserted. The user USB device can be configured to store a user profile or a user identifier or other data which is used by the controller 102 to determine whether access to arming and disarming functions should be permitted, or to which the controller 102 responds by arming or disarming the tracker. One or more manual switches 130 or a key pad or other user entry device can be coupled to the controller 102 as well. Such switches can be situated so as to be apparent to potential thieves to discourage theft, or can be concealed under or within a bike component. Alternatively, a flexible switch assembly can be defined on a flexible substrate and applied to a frame exterior and appear similar to a decorative decal. User contact with several switch elements in the assembly can be used to obtain authorization or to arm or disarm the tracker 100. Biometric devices such as retinal scanners, fingerprint detectors, voice recognition systems, and others can be used as well to gain access to tracker setup functions, or to arm or disarm the tracker 100.

A power path manager (PPM) 124 is coupled to a battery such as a LiPoly battery and is configured to control power consumption. The power manager 124 is also coupled to the controller 102. The USB connector 127 or a suitable alternative connector is coupled to the power manager 124 for use in charging the battery 126 from a power source. The USB connection is also coupled to the controller 102 so that tracker characteristics, identifiers, or configuration parameters can be stored in or retrieved from a removable memory device. In some alternatives, connections for other power sources such bicycle generators, solar power devices, or external batteries are provided for use in operation of the tracker 100 or charging the battery 126.

One or more alarm devices 132 such as light emitters, speaker, sirens, or tracking beacons may be coupled to the controller 102. The alarm devices 132 are configured to produce visible or audible indications of an alarm such as a bicycle theft alarm, or to show tracker response to arming, disarming, or configuration of the tracker 100 by a user. Alarm devices or other communication devices can be configured to alert a user to an unwanted disturbance, indicate a change in a tracker mode of operation, indicate a low battery condition, or that a component has been tampered with or removed. For example, a blinking indicator light can signal that a bicycle has been moved or that battery charging is necessary. Similar notifications can also be sent via wireless communications as well. In addition, a camera may be included to capture and relay images.

The tracker 100 may be configured to vary location reporting intervals based on bicycle speed and velocity. Typically, if a bicycle is stationary, only movement or vibration is reported and a continuing lack of movement is not reported, or is reported infrequently.

The tracker 100 can be implemented using a single substrate such as a rigid or flexible circuit substrate. In other examples, some components are not situated on a common substrate and are electrically connected with one or more cables.

Some or all components to the tracker 100 are continuously powered, while others are powered down until needed in response to an event or otherwise called into service. A representative embodiment of tracker power control is illustrated in FIG. 1B. The battery 126 is coupled to the PPM 124, and power to all system components is controlled by the PPM 124. The controller 102, accelerometer 112, and PPM 124 are typically continuously powered. The cellular radio 104 may operate directly from unregulated power and may be powered down by, for example, a p-FET power switch 130 controlled by a signal from the controller 102. The GPS receiver 106 and the transceiver 122 may each require lower operating voltages Vgps and Vkey, respectively. These voltages may be supplied by separate low-dropout series voltage regulators (LDOs) 132, 134 which may be selectively disabled by the controller 102. The controller 102 and accelerometer 112 may operate at a common voltage (Vuc), supplied by a common LDO 136. The LDO 136 is typically in on “on” state but may be powered on and off by a “soft” power switch 141. An enable pulse to the LDO 136 powers up the controller 102 which then provides an enable signal that is logically OR'd with an enable signal from the power switch 141. Additionally, a signal associated with power delivery to the USB connector 127 or other suitable power connector is OR'd with the Vuc enable signal to automatically power up the controller 102 to charge the battery 126 when the USB connector 127 is powered. Once Vuc is on, the controller 102 detects a second switch activation by periodically turning off the drive to the LDO 136. If a second activation of the switch 141 is detected, the controller 102 turns off the LDO 136, and thus the tracker 100.

Power saving can be implemented using a periodic, batch upload of event, disturbance, or other data with suitable time stamps instead of real time uploading in which data is uploaded as it is generated. If a bicycle is located in a secure area, a reduced power mode can be activated in which the tracker periodically confirms location, but is otherwise disabled or is in a low power state.

One or more or all tracker sensors are configured to respond to associated disturbances such as tilts, vibrations, translations, rotations, jostlings, altitude or temperature changes or unexpected temperatures. As used herein, an event is a disturbance or series of disturbances reported by one or more sensors based on default or user defined disturbance characteristics. Threshold levels, frequencies, durations, etc. and combinations of such characteristics can be user selected, and these values can be based on current tracker modes such as those discussed below. Nevertheless, disturbances that do not qualify as events can be discarded, recorded, or reported. A tracker is referred to as armed as configured to send an alert of a theft or a possible theft in response to one or more events. When a tracker is unarmed, events are logged or forwarded, but theft alerts are not sent.

Discrimination of routine disturbances from more serious disturbances can be based on an expected orientation of a bicycle (for example, tilted on a bike carrier on a trunk) or location in a usual region or along a frequently traveled route. Transport along public transportation routes (bus routes, light rail routes) can be detected based on position reports. Such transport can be indicative of theft or of user access to public transportation. If a user is carrying a cell phone that reports GPS or other coordinates, user location can be communicated to a cloud based server. If the user and the bicycle are determined to be following a common route, disturbances such as vibration, displacement, and jostling can be discounted as unlikely to indicate theft.

Tracker power can be provided in a variety of ways. Rechargeable or non-rechargeable batteries can be used, and on-board power generation/conversion sources such as solar panels, piezoelectric devices, and generators can be used. Bike-mounted battery packs (such as batteries in a water bottle shaped container) can be used. A wall power interface can be provided, and inductive coupling or direct connections can be used. A connector cable can be secured with one or more magnets.

The tracker 100 can be armed so that one or more events or series of events result in the tracker 100 producing an alarm notification that can be directed to a user or others. A user can set criteria for disturbances that indicate theft or unwanted activity. The tracker 100 can be user configured based on various user selectable parameters. For example, arming and disarming of a tracker and producing an alarm message can be done automatically or require user input. A frequency at which a tracker database (either at a tracker at a server) is updated can be selected. One or more motion or vibration detection procedures can be used to establish events.

The tracker 100 is preferably mounted to avoid detection and deter tampering. For example, the tracker 100 can be concealed within a water bottle cage or other component. The tracker 100 can also be made apparent so that potential thieves avoid a bicycle. One or more tracker antennas can be surface mounted to a frame as a flexible circuit or decal, in a frame interior, under handlebar grip tape, behind an antenna aperture or in a window defined in a frame, or defined as conductors within an insulating frame such as a carbon frame. If tamper resistant, making a tracker prominent or adding labeling may be effective as theft deterrent.

### Representative Tracker Operational Modes

A tracker such as shown in FIGS. 1A-1B can be configured to operate in a variety of modes, selectable by a user, or otherwise selected. Some operational modes are directed to managing battery lifetime by shutting down tracker functions except for periodic or occasional event detection and logging. Sensor signals can be processed in various ways to avoid false alarms or to ensure notification of even slight disturbances. The controller 102 can be configured to evaluate one or more series of events as to magnitude and frequency, and to correlate events detected at different sensors. Users can select which disturbances or series of disturbances should qualify as events based on user preferences.

Power management modes include an off mode in which the tracker is configured to resume operation in response to a user request or activation with a proximity key, a contact key, a mobile device, phone, computer or using another notification device or method such as a call to the service provider. In a sleep mode, the tracker is configured to monitor sensors, and resume operation in response to a sensor signal associated with, for example, motion or vibration, having signal characteristics that are user selectable, as well as in response to user requests for activation. A ride mode can be used to track rider routes/velocity/altitude etc. In this mode, typically no SMS or push notifications or alarms are sent. A ride route and start/stop times can be set, and alarms and notifications are not sent during riding within these ride parameters. Accidents can be detected based on sensor signals, and one or more emergency services or emergency contacts stored in a user profile can be notified, typically by communicating a request for such notifications to an internet based tracker service. Alternatively, the tracker can be configured to send suitable SMS, voice, or other messages directly via a cellular network. For example, the tracker can be configured to initiate a telephonic connection to an emergency (911) telephone number. A ride mode can also enable periodic or continuous communication of bicycle location for tracking by 3^{rd} parties such as parents, and 3^{rd} parties can be notified if a ride has not been completed within the predefined time or if the ride extends outside of the predetermined area.

### Operational Modes and Profiles

Numerous modes are user selectable. An “armed” mode provides a relatively high state of alert for theft, and in this mode a user is automatically alerted to events associated with possible thefts. A tracker may sound an audible alarm or flash a visible beacon, or trigger a tracker camera to take photographs. An armed mode can have different profiles so as to reduce false alarms. An “at home” profile can be used for known, secure locations in which inadvertent vibration and movement are not anticipated. A tracker temperature sensor can be used as a basis for an alarm as a bicycle may be anticipated to be in a home temperature environment in which temperatures are held within customary interior levels. A microphone configured to record sounds can be coupled to a controller to detect break-ins so that alarms can initiated and a user alerted. In a “public-unlocked” profile, the tracker is configured to be responsive to slight movements or displacements or other slight disturbances. The controller is configured to discriminate motion and noise associated with locking and unlocking adjacent bikes from noise associated with cutting a lock or removing bike from a rack. In a “public bike rack—locked” profile, some disturbances are permitted without triggering an alarm. A bicycle is not expected to move very far, and motions of a meter or more or some other distance are typically indicative of unauthorized motion. Noise or motion over a 30-45 second period (typical of bicycle theft) indicates possible theft. A “car rack” profile is configured to reduce false alarms and unwanted notifications when a bicycle is transported on a user's car. In this profile, vibration associated with car travel are not used to trigger alerts.

Either automatically (such as in response to events or disturbances), or upon instruction from a user device or other device, an alarm mode can be established in which the bicycle is assumed to be stolen. Police reports can be generated and submitted, stolen bike forums and bulletin boards can be notified or notifications broadcast to social media networks, selected contacts, neighborhood watch groups etc.

Online sales websites can be searched as well as other bulletin boards listing matching bicycles. A database of times and locations (position, time, speed, altitude and other data collected by on-board sensors) is generated and stored either locally or on a remote server. Tracker audio and visual alarms are activated. Alarm mode is cancellable upon receipt of a user instruction.

### Power and Battery Management

Power management may consist of turning off the cellular transceiver, placing the GPS receiver in low power standby, turning off any received signal strength (RSSI) indicators (if present), reducing use of other components, and keeping the controller in a low power mode. Battery levels are monitored and when a low battery threshold is approached, a low battery alert is transmitted to the server, and the tracker may power itself down in such a way that it will not wake up until power is available such as from a USB port or other suitable power port.

### Setting Management

Tracker setting changes may occur because of different activities such as a user request at the tracker via tracker input devices, or a request communicated from a server (perhaps initiated with a user mobile device), or communicated directly from a user device such as a mobile device, table, or other computing device. Locally made settings changes tend to be applied immediately, and then may be acknowledged to a server upon a next periodic alert or notification cycle so that server records are complete. Remotely made changes may be communicated during any communication between a tracker and a server.

### Proximity Keys

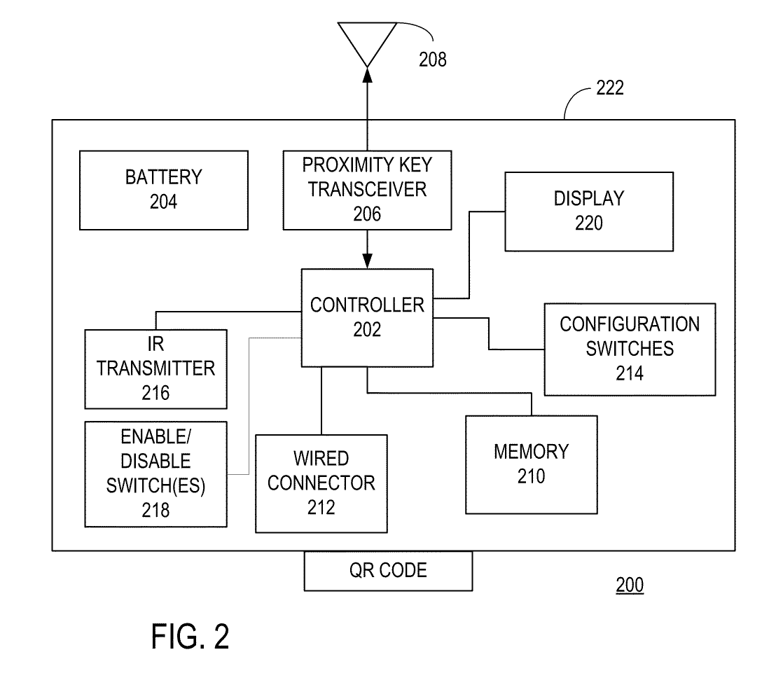

It can be convenient to activate tracker functions such as alarms or transmission of movement notifications based on a proximity key. A proximity key can be worn or carried by a cyclist so that tracker functions associated with normal operation by an owner or other authorized user are activated. When the proximity key is distant from the bicycle or undetected by the tracker, the tracker can enter an alarm or armed state to report movements and send alarms as needed. A representative active (powered) proximity key 200 is illustrated in FIG. 2. Alternatively, a passive proximity key, such as an RFID device may be used. A controller 202 is in communication with a proximity key transceiver 206, both of which are powered by a battery 204. The proximity key transceiver 206 is coupled to an antenna 208 so as to communicate with a bicycle or other tracking device. As shown in FIG. 2, the proximity key 200 includes a transceiver for two way communication, but in some examples, a transmitter is provided for one-way communication. The proximity key 200 can also include a communication port 212 such as a USB connection to permit configuring the proximity key 200 according to user selections. One or more configuration switches 214 are coupled to the controller 202 so that key operational parameters can be selected. An infrared transceiver (or transmitter or receiver) 216 can be included for optical communication with a tracking device. An enable/disable switch or switches 218 is coupled to the controller 202 so that user activation of the switch 218 enables or disables tracker functions. A display 220 is coupled to the controller 202. The display 220 can be used to indicate that a tracker is in an armed or unarmed or other state so that a user can confirm desired operation of the tracker. The proximity key 200 can also include a housing 222 to which a bar code or QR code is secured so that tracker functionality is enabled or disabled in response.

Typically, the proximity key 200 is configured to communicate with a tracker so that a tracker alarm function (or reporting or tracking function) is disabled whenever the proximity key 200 is within a predetermined distance from the tracker or so long as the tracker is situated so as to receive a signal from the key 200. For example, if a cyclist carries such a proximity key during riding, tracker functions such as alarms or alarm notifications are disabled. After the cyclist dismounts and is sufficiently distant, tracker alarm functions that were previously disabled are re-enabled. When the cyclist (with the proximity key) returns, tracker functions are again disabled. With the proximity key 200, the cyclist is not require to take any additional actions to enable/disable selected tracker functions when leaving or returning to her bicycle.

While the transceiver 206 can be an RF or low frequency transmitter, the optical transmitter 216 can be used. A transmitter can be configured to continuously or periodically transmit signals for reception by a tracker. Periodic transmission can reduce power consumption. Alternatively, a switch can be provided so that a user initiates transmission of a signal for use in enabling or disabling tracker functions. For example, the proximity key 200 can include an infrared transmitter and a suitable push button switch that is configured to initiate transmission of a suitably modulated optical signal. A proximity key can be configured for multiple communication modes (RF, optical) and can also include a bar code or QR code that can be scanned by a tracker to enable/disable tracker functions.

In some examples, the transceiver 206 is configured to receive an acknowledgement signal from a tracker, and activate the display 220 to indicate acknowledgement. For example, if a user disables tracking using the proximity key, the display 220 can be configured to indicate deactivation. In other examples, one or more of the configuration switches 214 are configured to permit the proximity key to be used to track separation of bicycle components. For example, the proximity key (either an active or a passive proximity key) can be secured to a cycle component so that tracking or alarm functions are initiated only upon separation of the proximity key and the tracker.

### USB Key

A memory device such as USB connectorized memory can be configured as a USB key that stores user authentication data, configuration files, or other data so that insertion of the USB key into a USB port at a tracker results in disabling tracker alarms. A tracker can verify user data or access codes stored on the USB key as well as set tracker options based on user profile data stored in the USB key. User verification can be determined by the tracker using data at the tracker, or user data or access codes can be communicated to an authorization service as a text message, voice message, email, or other data communication. In addition, transmitted authentication codes can be used to disable alarms, but still communicate user (i.e., bicycle) location for subsequent user reference, to establish use patterns, or to provide use data if the bicycle is loaned.

### Other Keys

Tracker arming and disarming can be executed by sending suitable SMS messages to the tracker or to one or more remote servers. Proximity keys as described above can be used, and bar codes or QR codes can be used. Biometric information (such as voice recognition, fingerprint, iris or retinal scans) can be used. Communications from a native application on a smart phone or PC or a web browser can be used as well. In addition, the tracker can be configured to auto-arm in response to being stationary for a predetermined time or in response to being located in a high-theft area.

### Tracker Device Network

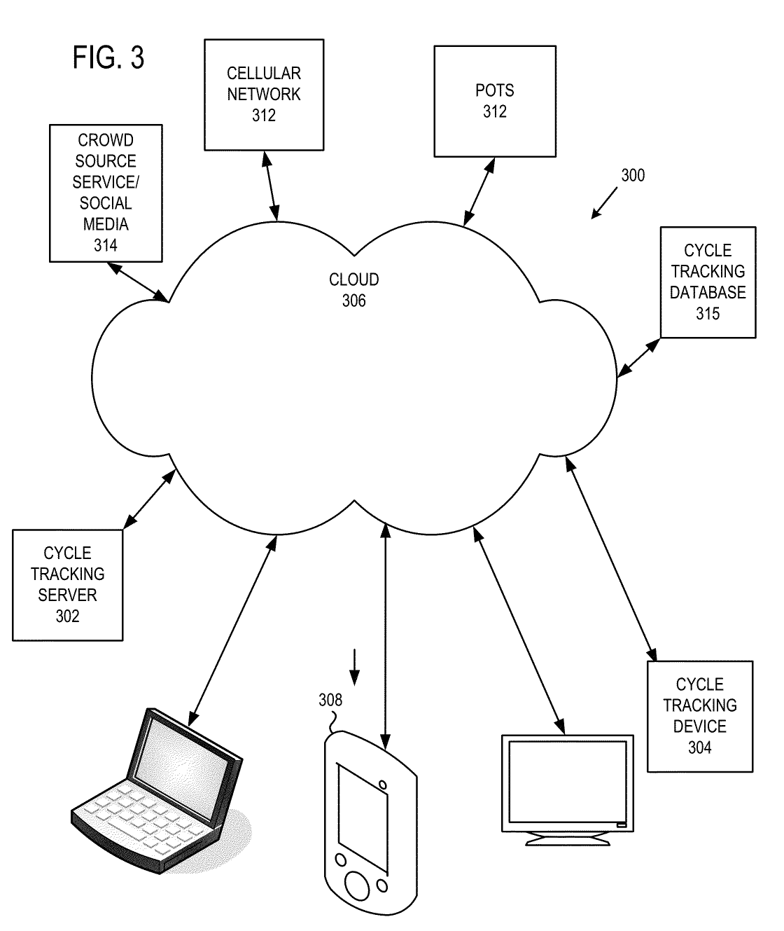

Referring to FIG. 3, a representative network 300 for cycle tracking includes a cycle tracking server 302 coupled to communicate with a cycle tracking device 304 via a wide area network, a local area network, or other network, shown in FIG. 3 as a cloud 306. The cycle tracking server 302 may be included in the cloud 306. Various user devices such as a laptop computer 308, a desktop computer 310, and a mobile device 312 can communicate with the tracking service server 302 via the cloud 306 or directly. The server 302 is coupled so as to receive notifications from the tracking device 304 concerning, for example, cycle position, movements, or other events as well as cycle and owner identifiers such as serial numbers, descriptions, names, contact numbers. In some example, the server receives communications from a user pertaining to user email addresses, phone numbers, social media account names so that the user or user contacts can be informed of cycle events. Some user information can be identified as private, while other information can be made generally accessible. The server 302 forwards messages or notification or related data received from the tracking device 304 to a user via one or more user devices such as the mobile device 308. The user communicates with the tracking device 304 through the server 302 or directly. Communication with or through a cellular network 312, a public telephone network 313, social media 314, and a cycle tracking database 315 can be implemented via the cloud 306.

20

### Tracking Device Server and Databases

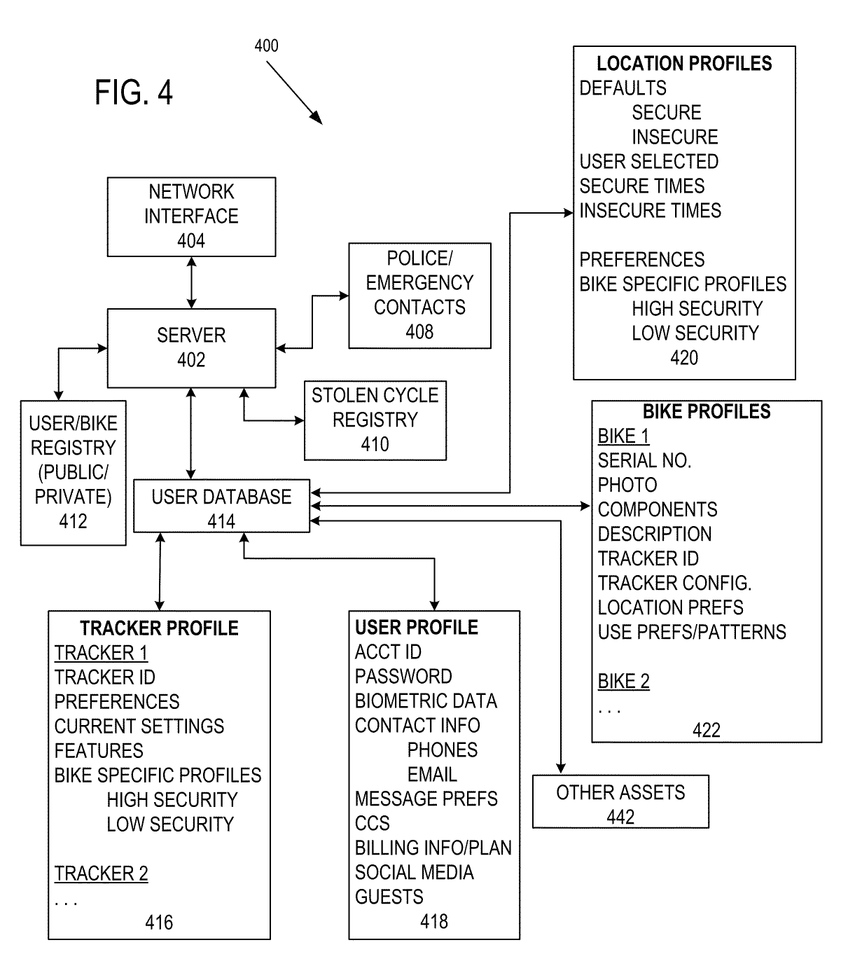

FIG. 4 illustrates a representative tracking service that provides a variety of services and is implemented at a single server 402 that is provided with a wired or wireless network interface 404 for communication via the internet, a cellular communication network, a public telephone network, a local area network, or other network. For coverage of small areas, network connectivity is not required, and tracking devices can communication with the server 402 without network access.

The server 402 is coupled to one or more memory devices such as disk drives or RAM that are configured to store user data or other data. Typically, a police/emergency contact database 408 and a stolen cycle registry 410 are coupled to the server 402. Contact information stored in the database 408 is retrievable so that thefts, accidents, injuries, or other situations can be reported to authorities. Police contact information is generally associated with particular locations, and a request for police contact information can include a current location of a bicycle tracker or a user so that the appropriate authorities can be notified. A stolen bicycle registry 410 includes identifiers associated with bicycles reported as stolen, whether or not the bicycle is associated with a service subscriber. A user/bike registry 412 can include user information and bicycle information for subscribers and non-subscribers, and users can elect the extent to which data provided is to remain private or can be made public.

As shown in FIG. 4, a user database 412 includes database for tracker profiles 416, user profiles, 418, location profiles 420, bicycle profiles 422, and other asset profiles 442. The tracker profile database 416 includes tracker device identifiers such as serial numbers or other IDs, preferred tracker settings, available features or features in use, bicycle specific profiles such as tracker settings associated with high security, low security or other default or custom security levels. Settings for a plurality of tracker devices can be provided, but only one is shown in FIG. 4.

The user profile database 418 includes user account identifiers, password, contact information such as phone numbers, email addresses, twitter handles, and mailing addresses. User biometric characteristics can be included. User message preferences pertaining to preferred notification formats (email, text message, etc.) along with other subscribers or non-subscribers to be copied are stored. Billing information such as credit card numbers, bank account information, billing plans, service subscription types are also stored. Social media names can be included as well. Sensitive data is encrypted for security, and data from the user database 414 for any user is available only to the bicycle tracking service unless wider availability is authorized by the user (opt-in), although opt-out can be used as well. Occasional or “guest” users of tracking devices and/or assets can be identified.

The location database 420 stores location information for a variety of default locations as well as locations provided by a user or obtained based on bicycle locations reported by a tracker. For example, certain geographical locations can be noted as secure or insecure based on frequency of bike thefts, availability of access, or other location features. For example, a location within an office building with no reported bike thefts can be noted as secure, while a sidewalk area outside a shop from which bike thefts are common can be noted as insecure. In addition, a user can establish user specific locations and associated security levels. An area inside a user garage even in an otherwise insecure area can be noted as secure. A user can establish such location data or override defaults (and common sense) as he wishes. Similarly, secure and insecure times of day (or days of the year) can be noted. User preferences concerning location-based security information can also be stored. In some examples, a user may elect to disregard location data, or to override default data, or to permit system defaults to configure trackers. Location profile data can also be tailored to be bicycle or asset specific, if desired. A more valuable asset can be constrained to treat all or nearly all locations as insecure, while a mixture of secure and insecure location assignments is used for a less valuable asset. Based on location profile data, the server 402 can communicate with a tracker so as to establish corresponding tracker functions. Trackers can be configured to report location more often in insecure locations, and to activate reports more easily in response to disturbances.

The bicycle profile database 422 is configured to store bicycle information such as serial numbers, photographs, model numbers, manufacturers, and component descriptions. In addition, a tracker assigned to a particular bicycle can be noted based on a stored tracker identifier, and one or more preferred tracker configurations or a current configuration can be stored. Use patterns can also be stored, so that users develop custom security profiles based on actual bicycle locations and riding patterns. For example, user rides that are routinely and almost exclusively trips to and from an office location associated with typical work hours can be used to identify unlikely trips (at unusual hours or days). Bicycle movement associated with unlikely trips can triggers a tracker to send alarms or transmit location data that would otherwise be deemed unnecessary. Such unlikely trips can be identified at the server 402 or at a tracking device.

While a tracking device can report location, in some examples, the server 402 is configured to receive data from the tracker to permit location determination. In one example, a tracker reports received signal strength (RSS) from nearby cellular network transmitters, and communicates RSS and transmitter identifiers to the server 402. Based on this data, the server 402 produces a location estimate using triangulation. Timing delays associated with nearby transmitters can also be used to estimate location.

For subscriber bicycles, bicycle identifiers such as serial numbers, model numbers, photographs and other information can be retrieved from user data for theft reporting to authorities or to insurance providers. The databases shown in FIG. 4 are shown at a common location, but can be distributed as may be convenient. The server 402 is generally configured to communicate with tracking devices as well as user desktop, laptop, or tablet computers, or mobile phones for messaging and data entry. In some examples, a tracker reports sensor data and position data or position-estimating data to the server 402. The server 402 then processes the data to determine if an alarm should be initiated, and returns an alarm command to the tracker.

### Mobile Devices for Asset Tracking

A tracker can be configured to communicate with a variety of user devices for setup, reporting, and control. So-called intelligent or “smart” phones can communicate directly or via cellular or other networks using a web browser interface, or a dedicated application. Communications and notifications can be based on push notifications, SMS texts, touch tones, or voice messages. Cell phones can be used as well, and communications transmitted via SMS, tones, and voice. Other suitable devices include laptops, desktop computers, tablet computers, and conventional non-cellular phones. User devices for law enforcement can be configured to access bicycle theft data for date mining and to receive geoalerts for some or all tracked devices an correlate stolen bicycle locations with current law officer locations.

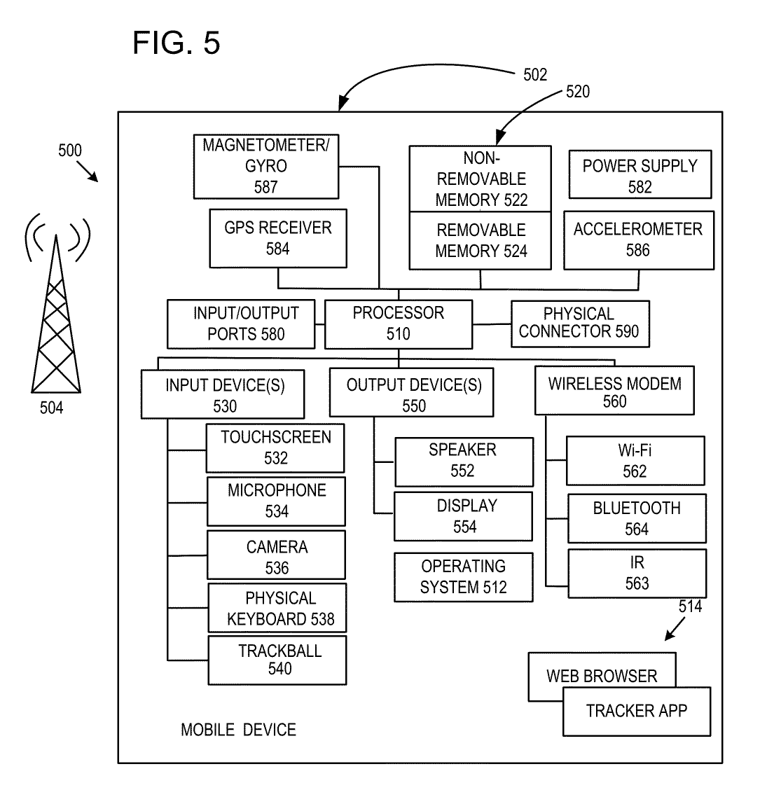

Mobile devices are particularly convenient. Mobile devices can be configured to provide tracking profile data to a service provider, establish tracker settings and functions by communication with a tracker via the internet, cellular network, or other network, or by communicating directly with a tracker. In addition, mobile devices can be configured to serve as proximity keys. FIG. 5 is a system diagram depicting an exemplary mobile device 500 including a variety of optional hardware and software components, shown generally at 502. Any components 502 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 504, such as a cellular or satellite network.

The illustrated mobile device 500 can include a controller or processor 510 (e.g., signal processor, microprocessor, ASIC, or other control and processing logic circuitry) for performing such tasks as signal coding, data processing, input/output processing, power control, and/or other functions. An operating system 512 can control the allocation and usage of the components 502 and support for one or more application programs 514. As shown in FIG. 5, a dedicated or “native” tracker application is provided along with a Web browser, both of which can be configured to access tracker functionality simultaneously. The application programs can also include common mobile computing applications (e.g., email applications, calendars, contact managers, messaging applications, social media), or any other computing application.

The illustrated mobile device 500 can include memory 520. Memory 520 can include non-removable memory 522 and/or removable memory 524. The non-removable memory 522 can include RAM, ROM, flash memory, a hard disk, or other well-known memory storage technologies. The removable memory 524 can include flash memory or a Subscriber Identity Module (SIM) card, which is well known in GSM communication systems, or other well-known memory storage technologies, such as “smart cards.” The memory 520 can be used for storing data and/or code for running the operating system 512 and the applications 514. Example data can include web pages, text, images, sound files, video data, or other data sets to be sent to and/or received from one or more network servers or other devices via one or more wired or wireless networks. The memory 520 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 500 can support one or more input devices 530, such as a touchscreen 532, microphone 534, camera 536, physical keyboard 538 and/or trackball 540 and one or more output devices 550, such as a speaker 552 and a display 554. Other possible output devices (not shown) can include piezoelectric or other haptic output devices. Some devices can serve more than one input/output function. For example, touchscreen 532 and display 554 can be combined in a single input/output device. The input devices 530 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 512 or applications 514 can comprise speech-recognition software as part of a voice user interface that allows a user to operate the device 500 via voice commands. Further, the device 500 can comprise input devices and software that allows for user interaction via a user's spatial gestures, such as detecting and interpreting gestures to provide input to a gaming application.

A wireless modem 560 can be coupled to an antenna (not shown) and can support two-way communications between the processor 510 and external devices. The modem 560 is shown generically and can include a cellular modem for communicating with the mobile communication network 504 and/or other radio-based modems (e.g., Bluetooth 564 or Wi-Fi 562) and an IR transmitter/receiver 563. The wireless modem 560 is typically configured for communication with one or more cellular networks, such as a GSM network for data and voice communications within a single cellular network, between cellular networks, or between the mobile device and a public switched telephone network (PSTN).

The mobile device can further include at least one input/output port 580, a power supply 582, a satellite navigation system receiver 584, such as a Global Positioning System (GPS) receiver, a magnetometer and gyro 587, an accelerometer 586, and/or a physical connector 590, which can be a USB port, IEEE 1394 (FireWire) port, and/or RS-232 port. The illustrated components 502 are not required or all-inclusive, as any components can be deleted and other components can be added.

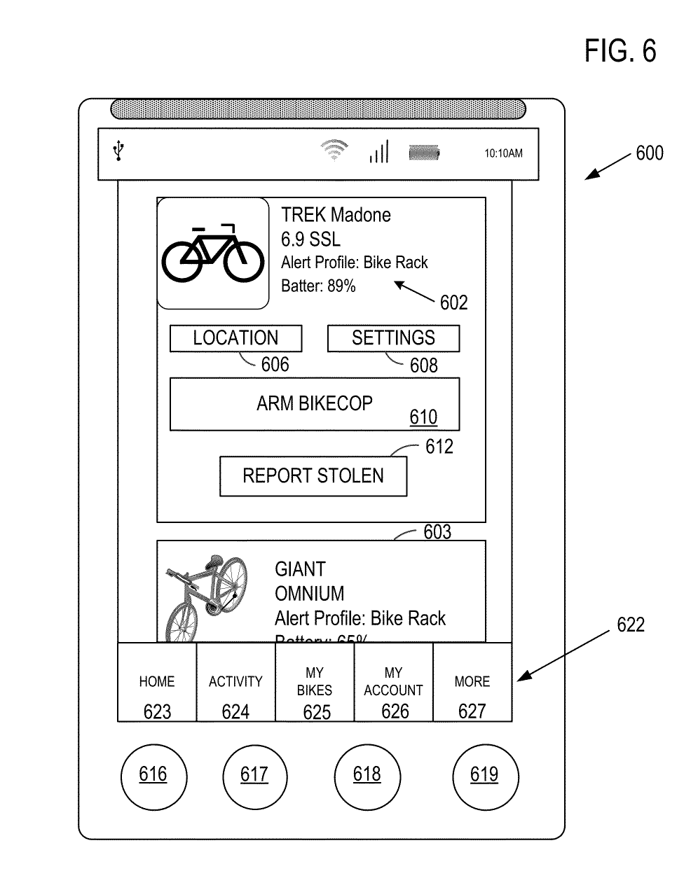

FIGS. 6-11 are screen shots of representative user interfaces for entry and display of tracker settings, tracker status, and other communications with trackers, tracking service providers, or proximity keys. FIG. 6 is a screen shot 600 of a mobile device display that illustrates portions of a bike profiles at display areas 602, 603. Profile and other data including bicycle descriptions, alert profile status (bike rack status as shown), and battery power remaining are displayed for two bicycles and the associated trackers. The active bike/tracker is shown in the area 602. Touchscreen areas 606, 608 are provided to request current tracker location from either a tracker or a service provider, and to request display (or editing) of tracker and other settings, respectively. A touchscreen area 610 is configured to arm or disarm a tracker in response to user inputs, and can be displayed in color to indicate status. A touchscreen area 612 is provided for indicating that a bicycle is stolen and initiating reporting based on established settings. Physical buttons 616-619 can be assigned as convenient for user input as well, and touchscreen inputs are not required. A selection bar 622 could include home, activity, my bikes, my account areas 623-627 that are assigned for user requests to return to a home screen, receive tracker activity information, access bike profiles, and user account information. An area 627 is assigned to request additional display options.

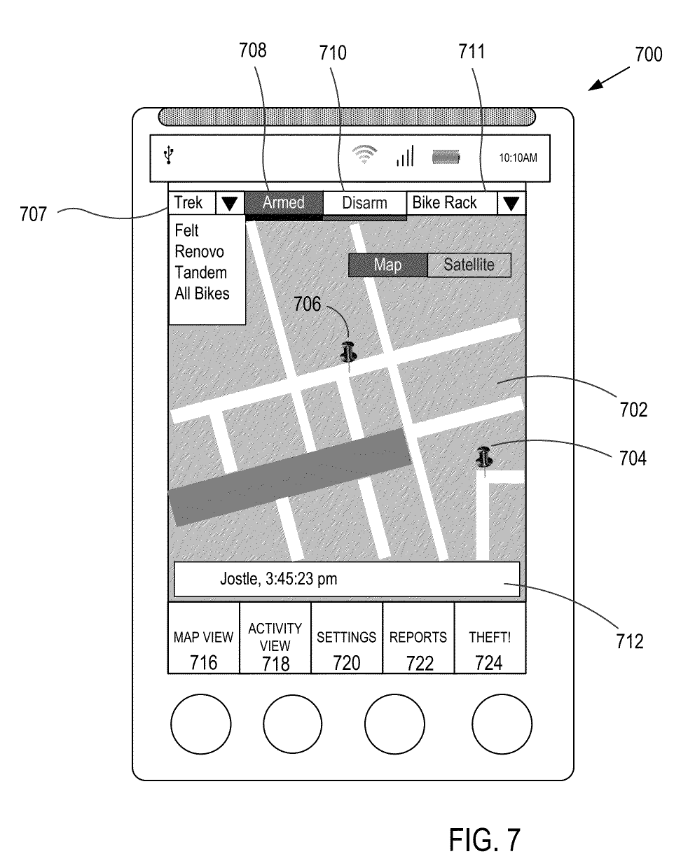

FIG. 7 is a representative screen shot 700 of a tracking screen map view that displays a map 702 and pushpins 704, 706 that indicate current and recent tracker locations. Other map icons that can be displayed include so-called “bread crumb” locations showing bicycle movements and a route along the bread crumbs. Different styles and or colors or gray levels of pushpins or other position indication icons can be used to discriminate recent locations from earlier locations. Locations such as bicycle safe zones, high theft zones, or other areas of interest can be marked with differing colors or otherwise marked. A region in which numerous stolen bicycles are detected can be indicated, and a corresponding map forwarded to law enforcement.

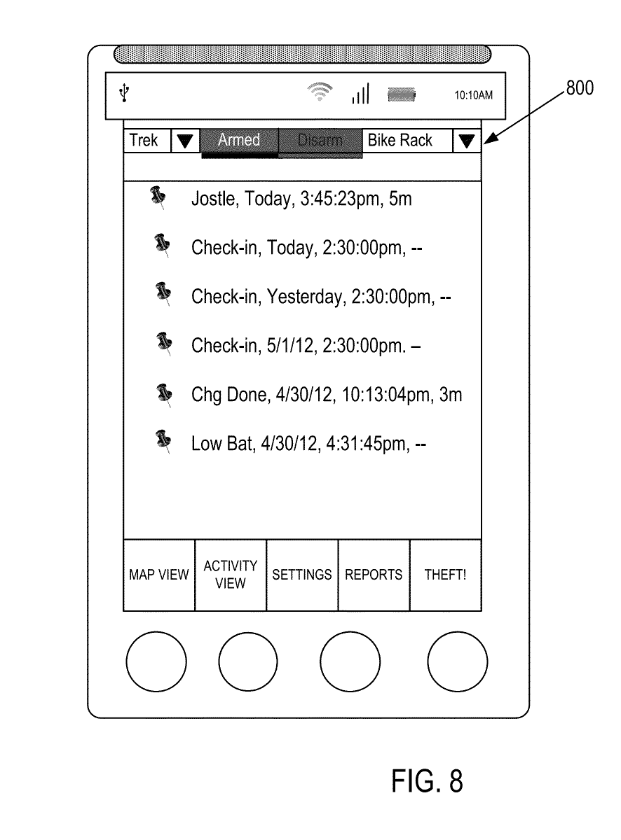

A drop down menu area 707 is provided for user selection of one or more bicycles whose positions are to be displayed on the map 702. A status area 708 displays whether or not a tracker is armed, and areas 708, 710 permit toggling between armed and disarmed. A drop down menu 711 is provided for motion alert profile settings, with a bike rack setting shown in FIG. 7. In a bike rack setting, some jostling of a bicycle is permitted without triggering an alarm, but displacements from a current location and other unexpected vibrations and movements trigger an alarm. A most recent activity display area 712 shows events detected by a tracker. As shown in FIG. 7, the tracker is reporting jostling of the bicycle at a particular time. A menu selection 714 provides user input area 716, 718 for selection of a map view (shown in FIG. 7) or an activity view that lists events. In addition, a settings area 720 permits access to various tracker device and service settings, and a reports area 722 and a theft alarm 724 permit a user to request a report on bicycle activity or forward a notification of theft, respectively. FIG. 8 is a screenshot 800 showing an event view in which tracker events are shown in chronological order. Representative events reported include jostling or other bicycle movements, location “check-ins,” profile changes, and low battery warnings.

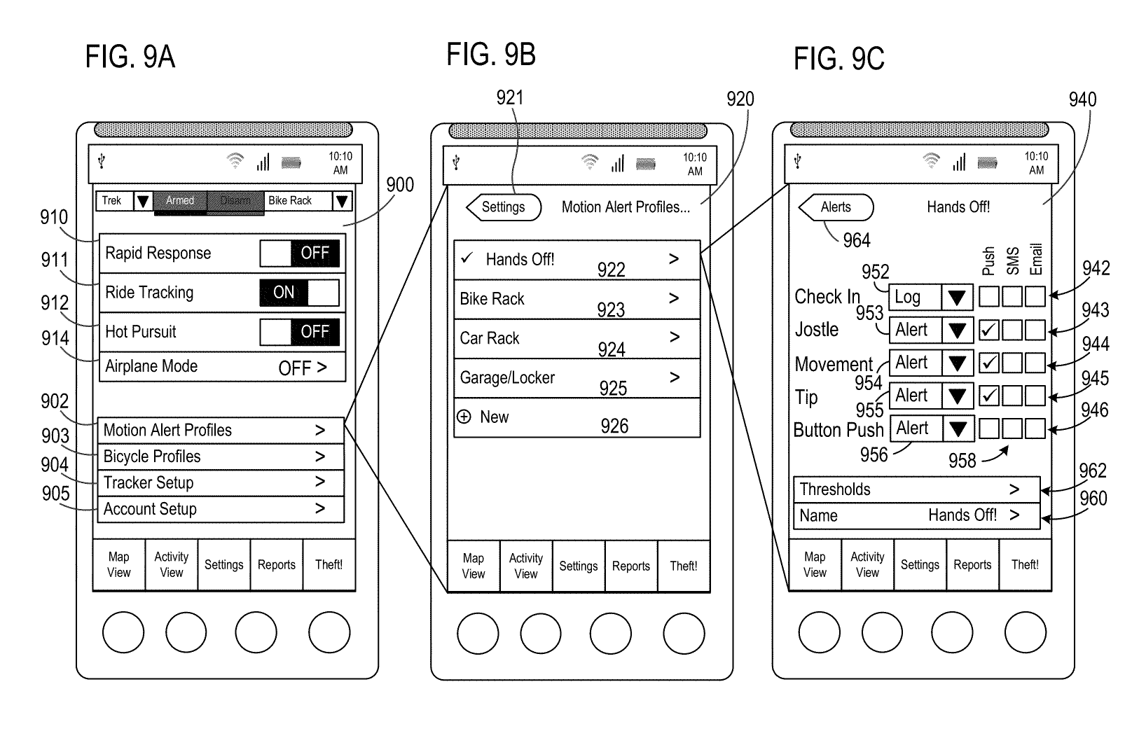

FIGS. 9A-9C show screenshots 900, 920, 940 provided for user customization and selected of tracker performance parameters, particularly motion alert profiles. As shown in FIG. 9A, user input areas 902-905 are provided to permit a user to view, modify, or select motion alert profiles, bicycle profiles, tracker setup, and account setup, respectively. On/off switch areas 910-913 permit user activation of one or more of rapid response, ride tracking, and hot pursuit modes. The hot pursuit mode is provided for device operation in response to a theft has been confirmed and a bicycle is being actively tracked. Update rates may be increased and additional functionality may be activated (such as flashing lights, alarms or tracking beacons) to allow for precise real-time location of the bicycle, especially if it is in motion. Hot pursuit mode may be activated or deactivate by the user, at the request of a law enforcement agency, or automatically by the tracker. Because this mode may consume excess power that could rapidly deplete the batteries, it is typically used only when location of the device is imminent. An airplane mode setup screen can be selected at 914.

The screenshot 920 of FIG. 9B shows a mobile device display upon selection of the motion alert profile in FIG. 9A. As shown in FIG. 9B, four motion alert profiles are shown (hands off, bike rack, car rack, garage/locker) in respective user selection areas 922-925, and a user selection area 926 is provided for definition of a new motion alert profile. A settings area 921 is used to return to a settings screen such as shown in FIG. 9A.

The screenshot 940 of FIG. 9C shows a mobile device display upon selection of the hands off motion alert profile in FIG. 9B for a particular bicycle. As shown in FIG. 9C, five motion alert settings are shown for various events (check ins, jostles, movements, tips, button pushes) in respective user selection areas 942-946. Each of these selection areas includes respective drop down menu areas 952-955 to permit a user to request that the associated event be logged for subsequent review or reported upon occurrence. One or more reporting methods such as push notifications, short message service messages, or email can be selected with an array of associated check boxes 958. Access to profile name editing is provided at an area 960, and thresholds or other values used to define events can be edited by selection of the display area 962. Representative event thresholds can be associated with jostle magnitude or frequency required to define a loggable or reportable jostle event (and different values can be assigned for each), check-in frequency (i.e., frequency of location reporting), and magnitude of bicycle displacements. In some examples, these settings can be based on location profiles. A settings area 964 is used to return to a motion alert profile screen such as shown in FIG. 9B.

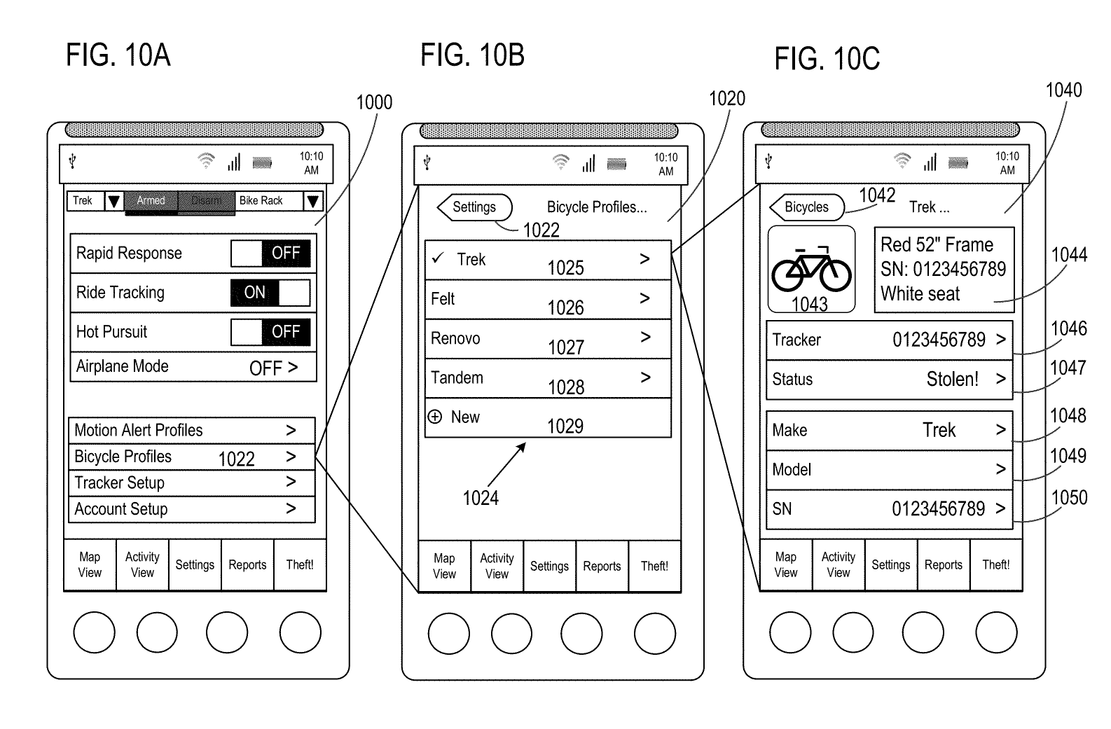

Screenshots 1000, 1020, 1040 of FIGS. 10A-10C show mobile device displays and menu items for configuration of one or more bicycle profiles. The screenshot 1000 is similar to that of FIG. 9A, but shows selection of a bicycle profile screen area 1002 that results in the display shown in the screenshot 1020 of FIG. 10B. A settings area 1022 is provided to return to the settings screen of FIG. 10A, and a display area 1024 includes user selectable areas 1025-1028 associated with user bicycles and an area 1029 for indicating that a new bicycle is to be added. Selection of the display area 1025 for the bicycle labeled “Trek” results in a mobile device display as shown in the screen shot 1040 of FIG. 10C. A bicycle selection area 1042 is provided to return to the screen of FIG. 10B. Bicycle profile parameters are displayed and input by selection of a photograph area 1043, a description area 1054, a make area 1048, a model area 1049, and a serial number area 1050. An associated tracker can be identified at are 1046 that may be configured as a drop down menu that contains a listing of a user's trackers. A status area 1047 displays and permits entry of bicycle status such as stolen, missing, at home, at work, on a ride, borrowed, or other status. Additionally, at any time, the user may send a request to receive a report of the position or other data about the bicycle.

In typical embodiments, independent profiles can be established for each of a user's bicycles, and current tracker assignments noted. For users with multiple bicycles, a bicycle identifier is included in messages to and from a tracker to confirm which bicycled is currently being tracked.

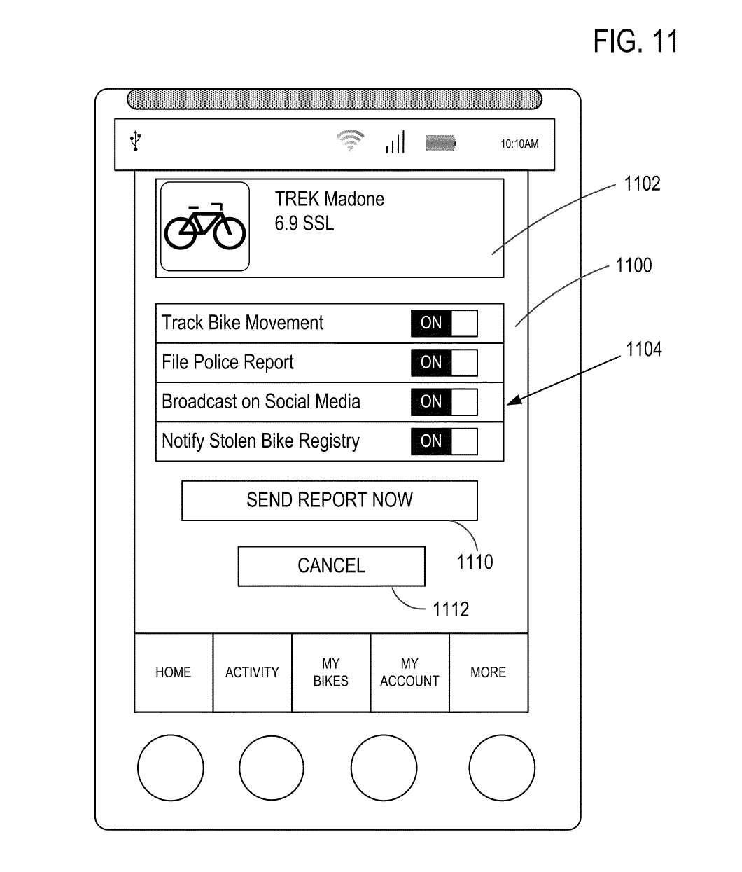

FIG. 11 shows a screenshot 1100 that can be used to set up reporting options. A display area 1102 is provided for bicycle information, and a display area 1104 is configured to provide on/off selection of bicycle tracking, police reporting, social media broadcasts of tracking or theft notifications, and notification of a stolen bicycle registry. An input area 1110 is provided for user requests to send reports, and a cancel area 1112 returns to a previous display screen.

### Auxiliary Theft Sensors

An RF receiver similar to that used in a proximity key can be used to monitor the presence of auxiliary transceivers, which may be attached to components or accessories of value attached to the bicycle, such as the wheels, the seat, bike bags, a bike trailer, etc. The user may associate these transceivers to a tracker, and configure the tracker to periodically poll these transceivers. If an expected transceiver does not respond within a certain number of communication attempts, the tracker may report the missing transceiver to the server as a possible tampering or theft event such a theft of a component. Other methods of sensing removal of components, such as tamper switches or other continual monitoring of component position relative to the tracker may be used.

### Unique Tracker Identifiers (UIDs)

A unique identifier (UID) may be attached to a tracker to allow contact with the bicycle's owner. Additionally, a second UID may be attached elsewhere on the bicycle in a location more readily accessible than the tracker. This UID may be implemented as a printed number, a 1D barcode, a 2D barcode, such as a QR code, and/or a RFID tag in the form of a planar antenna and microchip as is used for inventory tracking, or in the form of a capsule, as is used for pet identification. When a bicycle is found or recovered with a UID, the number may be directly entered into the app or a website page, or the barcode may be scanned from within the app using a smart-phone's camera. Submitting the UID may either pull up the submitted record if the bicycle has been reported stolen, or bring up a contact form if the bicycle has not been stolen. In either case, the UID submitter may send a message to the registered owner of the bicycle.

### Tracker Service Access

Web-based tracker services can be accessed using a standard browser or a native application, or with two way communication via SMS text or similar text or data communication method. A native application can be downloaded to a user device, but provided with limited functionality until the device is associated with a service subscriber. Additionally, the tracker may be accessed through other methods with limited functionality. An introductory free period of use can be provided.

### Representative Message Contents and Types

A tracker can be configured to include at least the following data in messages to user devices or cloud based servers. Messages need not include all such data, and can be configured as convenient.

Tracker Message Data
UTC date and time
Latitude, Longitude, Altitude
GPS fix indication, no. of GPS satellites
(HDOP (determined from GPS or location-based services)
Cellular received signal strength indication (RSSI) and bit error rate (BER)
Battery level
Accelerometer status bits
Type of alert (motion, transient, orientation change, periodic, battery low)
Cellular unit unique ID
Packet counter
Armed/Disarmed
Temperature

Communications from a server or user device to a tracker can include at least some or all of the following:

### User Message Data

Desired armed state (0, 1)
Periodic update rate (minutes)
Enabled events mask (8 bit ASCII hex value)
Event thresholds (4 16 bit ASCII hex values)
Cellular unit unique ID confirmation
Packet counter confirmation

Representative message types from a tracker are listed in the following table:

### Representative Message Types

Jostle (soft, medium, high, duration, frequency)
Movement (out of safe zone, velocity, altitude)
Tilt
Change of position
Theft (possible, probable, confirmed)
Battery level
Cell signal level
Out of range

Representative message types from a user to a tracker or an associated tracker server include:

### Tracker Message Data

Request for status
Request for location
Internal electronic stored data (time stamped position)
External database information (history of alerts, settings)
Current sensor data
Current application settings
System commands
Mode changes
Arm/disarm commands)
Power saving commands
Packet counter
Armed/Disarmed
Temperature

### Auto Arming and Manual Arming

Tracking devices can be instructed to initiate tracking and alarm generation manually in response to a user request transmitted from a proximity key, a laptop, cell phone, or other device. A user request can be directly transmitted or transmitted via the internet or other network. Tracking devices can also be armed using a biometric device. Tracking devices can also be armed automatically based on time of day, placement in or out of predetermined locations, or user profiles associated with typical user rides. A mobile device or proximity key or other device can be used to transmit instructions concerning tracker arming. For example, if a user discovers that a bicycle is missing or stolen, the user can request activation in an alarm mode using a mobile phone.

### Representative Communication Method

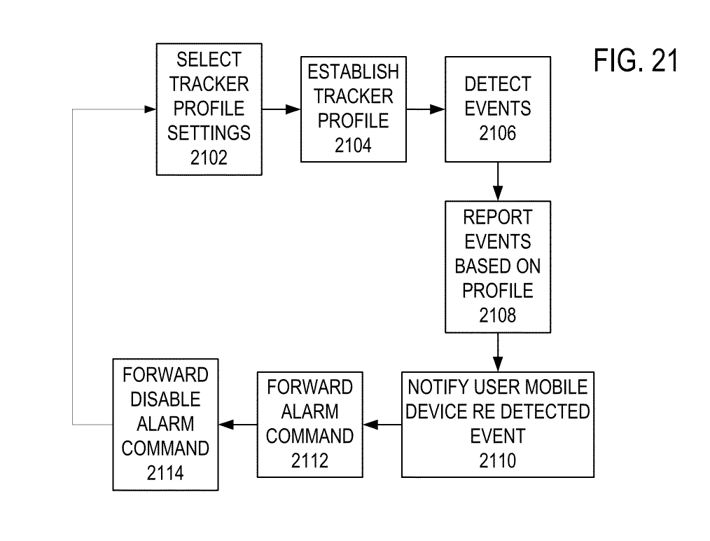

With reference to FIG. 21, a representative communication method includes selecting tracker profile settings at 2102. The selected settings are then used to establish a tracker profile at 2104. The settings can be selected at various user devices (or locally at the tracker) and communicated from the user device to the tracker or from the user device to a bicycle tracking server and then to the tracker. In operation, the tracker reports events at 2108 based on tracker profile settings. At 2110, the tracker detects an event and forwards a message associated with the detected event or events. The message can be directed through a network such as the internet or a cellular network to a bicycle tracking server. The server then sends a corresponding message to a user mobile device at 2110, and based on the message, an alarm message is forwarded at 2112 from the user mobile device (alternatively, no action is taken). At 2114, an alarm disable command is communicated to the tracker if an alarm state is no longer deemed appropriate. Upon exiting the alarm state (or at any other time), tracker profile settings can be revised at 2102.

Additional processing at the server (or user device) can be used to generate or evaluate messages to interpret and analyze data received from the tracker to decide what information, if any, to send to the user, police, social networks etc., as well as how such messages should be sent (text, push notification, email, automated telephone call). Messages can be evaluated to determine if user-directed messages should also be directed to other destinations such as those in a user defined contact list. The server may query the user for guidance or it may operate autonomously using information from a variety of resources including, but not limited to user settings, tracker mode, information from the database of other users about such things as known theft hotspots, or other external databases such as stolen bike registries.

### Example Tracker Configurations

A tracker may be mounted in one of a number of locations on a bicycle, including locations external to the frame, locations inside the frame, or a combination of the two. For external mounting, the tracker may be disguised as a common bicycle accessory or hidden within an existing component, including a bicycle seat, a bicycle pump, or a water bottle rack. For internal mounting, the entirety of the tracker may be installed in non-conductive (RF transparent) frames, including wood, fiberglass, or carbon fiber frames, or the electronics and battery of the tracker may be installed in the frame, and the antennas installed outside the frame, with RF connections made between the tracker and the antennas via RF cables and connectors routed through one or more portals in the frame. An RF portal can be painted to disguise its presence. Alternatively, the antennas may be installed inside the frame with special RF-transparent windows designed into the frame, or the antennas may be directly integrated into a non-conductive section built into the frame.

### EXAMPLE 1

### Water Bottle Enclosures

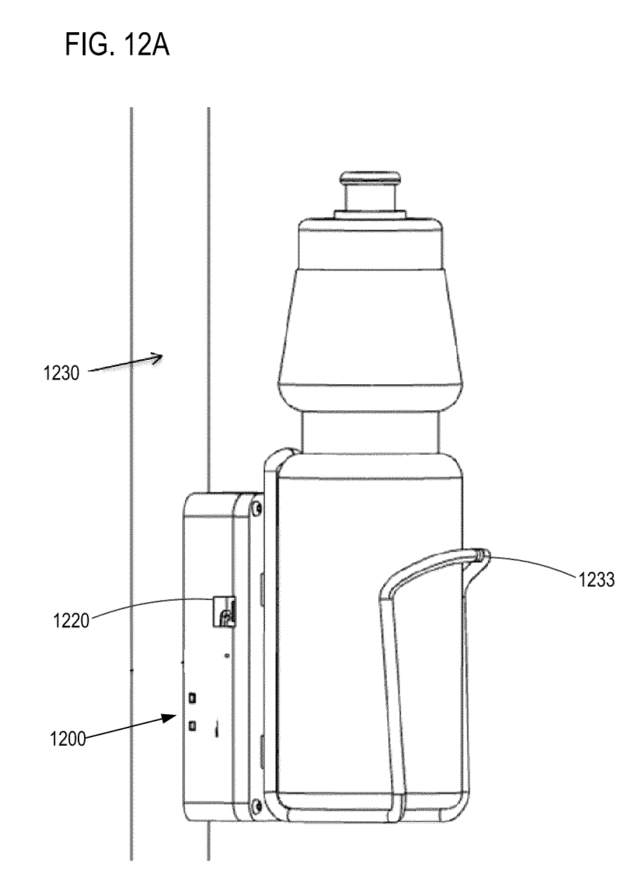

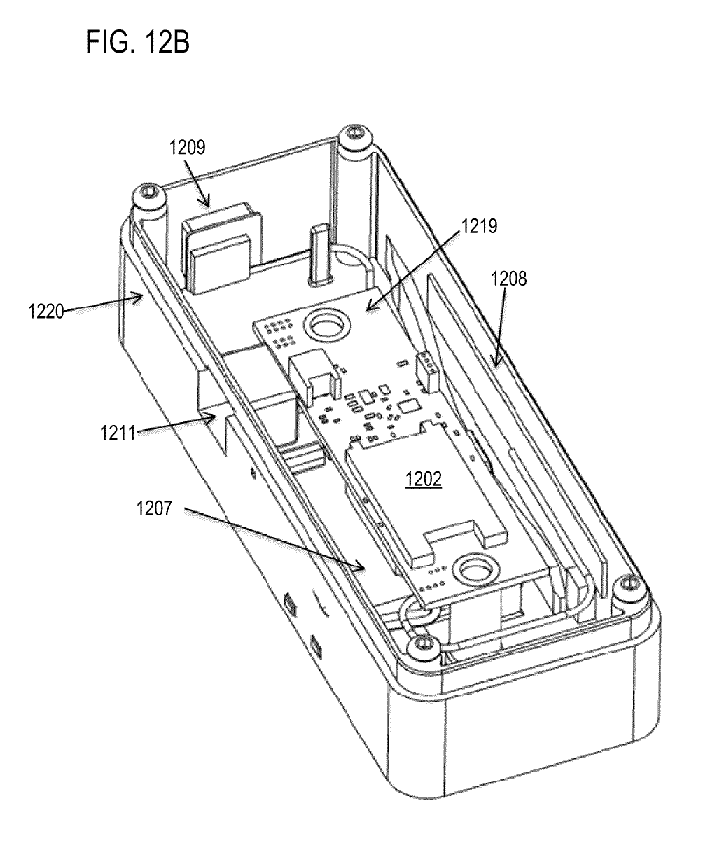

With reference to FIGS. 12A-12B, a tracker 1200 is built an enclosure 1220 that is configured to be attached to a bicycle frame tube 1230 so as to support a water bottle rack 1233. The enclosure 1220 may be integrated with water bottle rack 1233 or be provided as a standalone enclosure to which the water bottle rack is mounted. As shown in FIG. 1B, the tracker includes a battery 1207, a cellular antenna 1208, a circuit board substrate 1219, a satellite antenna 1209 and satellite receiver, a cellular radio, and a microcontroller. An ISM band transceiver and antenna are included, and a housing aperture 1211 is configured to retain a USB connector.

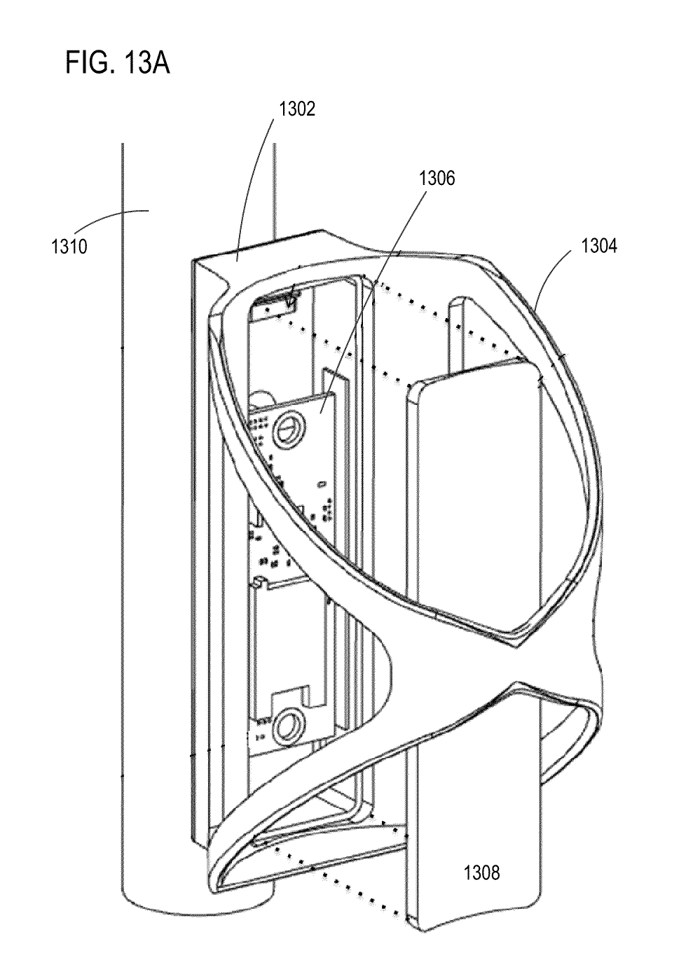

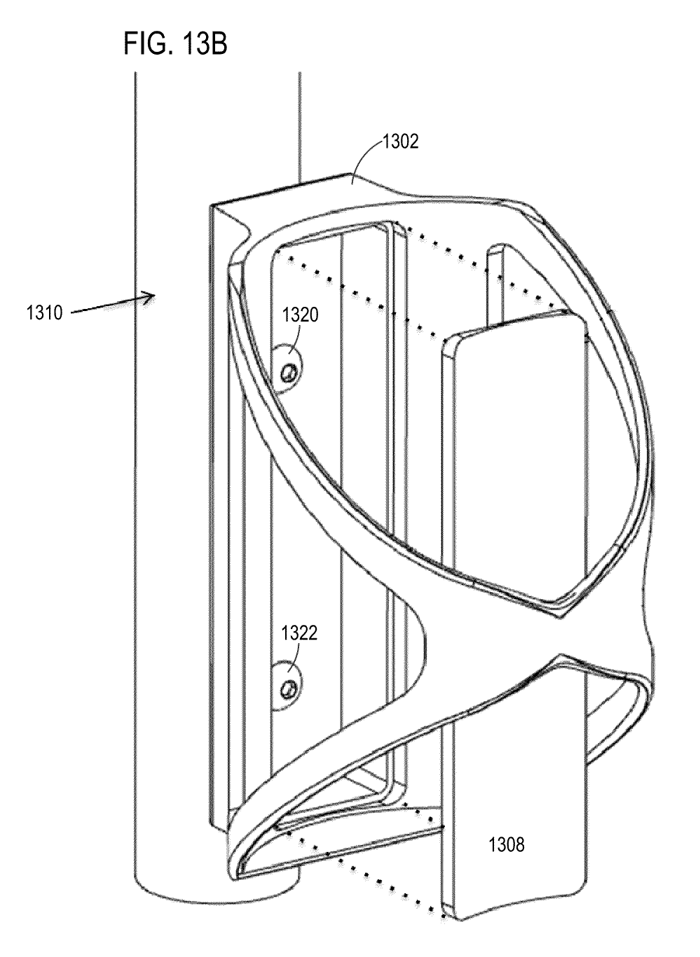

In an example illustrated in FIG. 13A-13B, an enclosure 1302 is integrated with a water bottle rack 1304 and is configured to contain a tracker substrate 1306 and other tracker components such as battery, antennas, and transmitters/receivers. The enclosure 1302 can be sealed with a cover 1308. Alternatively, the enclosure 1302 can be left empty to serve as a storage compartment as shown in FIG. 13B which also shows screws (or security screws) 1320, 1322 that serve to fasten the enclosure 1302 to a bicycle frame tube 1310. Other more secure methods of attachment of the tracker to the bicycle, such as high strength adhesive or tape, may be used as well. The existence of both tracker-enabled water bottle racks and empty-compartment water bottle racks aids in obfuscating the existence of the tracker, and allows the bicycle owner to install multiple matching water bottle racks without needing to purchase multiple trackers.

### EXAMPLE 2

### Within-Frame Trackers

In other embodiments, electronics and battery of a tracker are housed within an enclosure installed inside a bicycle frame at, for example, just behind water bottle mounting screw holes. RF antennas are built into a water bottle cage and attached to the tracker via RF connectors that may be constructed either in water bottle rack mounting screws, or pass through a center of hollow-core versions of screws, or within channels along one side of screws that allow screws to be slipped over an RF cable before installation. Alternatively, antennas may be built into a water-bottle rack base, which can then be provided as a component to water-bottle rack manufacturers for incorporation into water bottle rack designs. Such a design may comprise a base unit and a cover that is secured in place to enclose the mounting screws and antenna connection in order to provide protection from tampering and both accidental and intentional damage.

### EXAMPLE 3

### Seat Pack Trackers

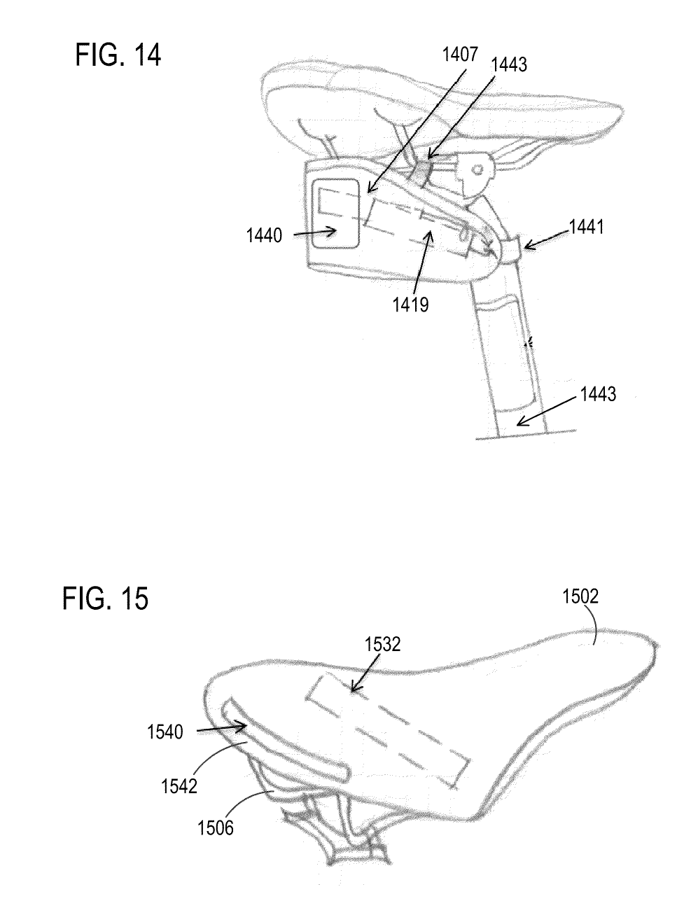

In another example, a tracker is built into a seat pack 1402 as shown in FIG. 14. A circuit substrate such as a PCB 1419 is sewn into one pouch on the inside of the pack 1402, a battery 1407 inside a second pouch, with wire connecting the two and unobvious or undetectable to casual perusal. Antennas may be inside the pack 1402 or may be outside the pack 1402 at the rear, disguised as a product label 1440 or in connection with a seat post attachment 1441 or as a decal 1442 on the seat post 1443 or elsewhere outside the pack 1402. The seat post attachment 1441 or a seat rails attachment 1443 may be lockable and secure so that pack 1402 is not easily removable.

### EXAMPLE 4

### Under Seat Trackers

In another embodiment shown in FIG. 15, a tracker 1532 is located under a seat 1502 and secured to a seat bottom or seat rails 1506. An antenna 1540 is attached to a back 1542 of the seat 1502 as a “label” or is situated below the seat1502 in a hidden design or as a visible decal.

### EXAMPLE 5

### In Handlebar Trackers

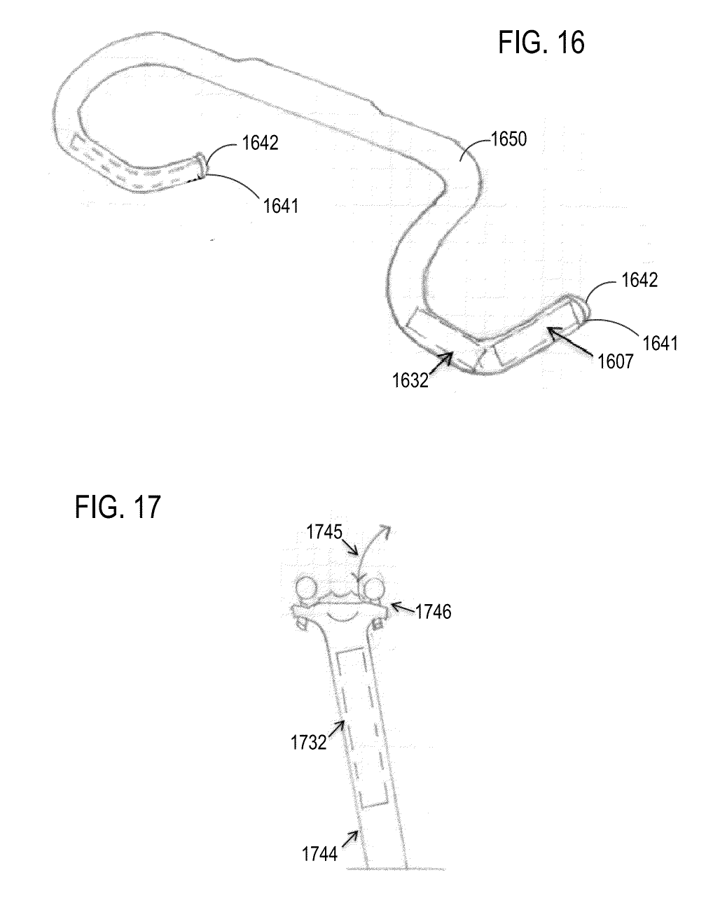

In another embodiment shown in FIG. 16, a tracker 1632 and a battery 1607 are inserted into handlebar ends 1641, so that antennas extend through one or both handlebar end caps 1642. Alternatively, antennas are wrapped around handlebars 1650 and disguised as brake wires or decals or concealed with handlebar tape.

### EXAMPLE 6

### Seat Post Trackers

In another embodiment shown in FIG. 17, a tracker 1732 is built into a seat post 1744, with antenna cables 1745 emerging from a hole in a seat mounting bracket 1746. Antennas could then mounted under the seat or on the back as shown above.

### EXAMPLE 7

### Accessory Mounted Trackers

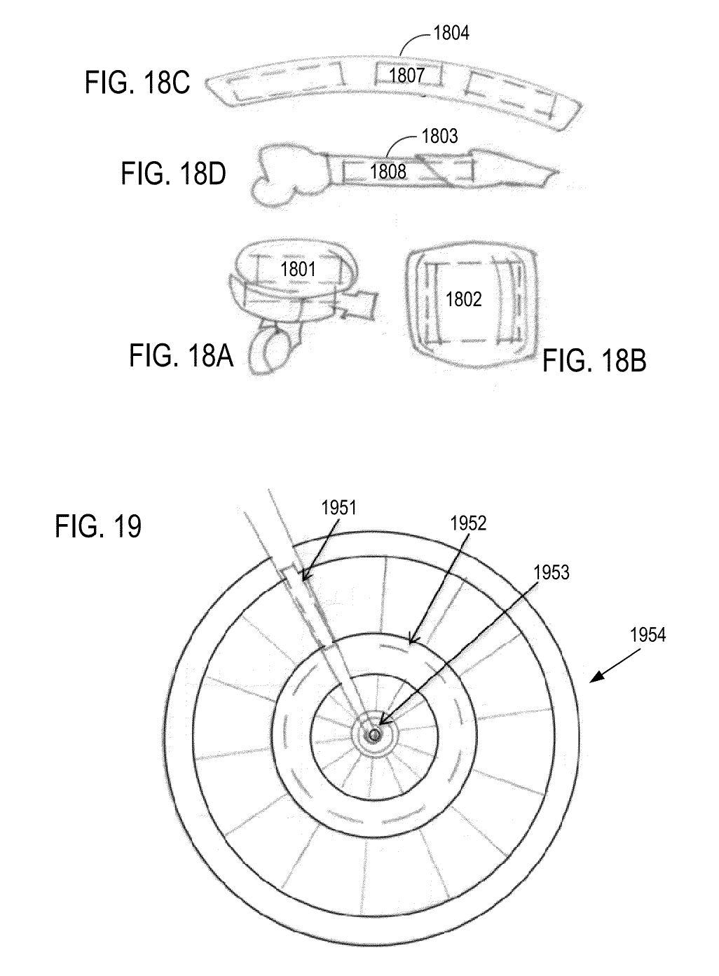

In other embodiments, trackers 1801, 1802 1803 1804 are disguised as or in a standard issue accessory such as a bell (1801), reflector (1804), light (1802), air pump (1803) as shown in FIGS. 18A-18D. Such an accessory may be specially locked and or screwed to bicycle in a manner that makes removal difficult.

### EXAMPLE 7

### Other Trackers

In another embodiment, trackers are built into a bicycle fork 1951. a wheel hub 1953, or into a disk assembly 1952 on a wheel 1954 as shown in FIG. 19. In these examples, the wheel 1954 can be configured to serve as an energy source for battery charging and tracker operation, and antennas may be circular and may rotate with the wheel 1954.

### Computer Environment

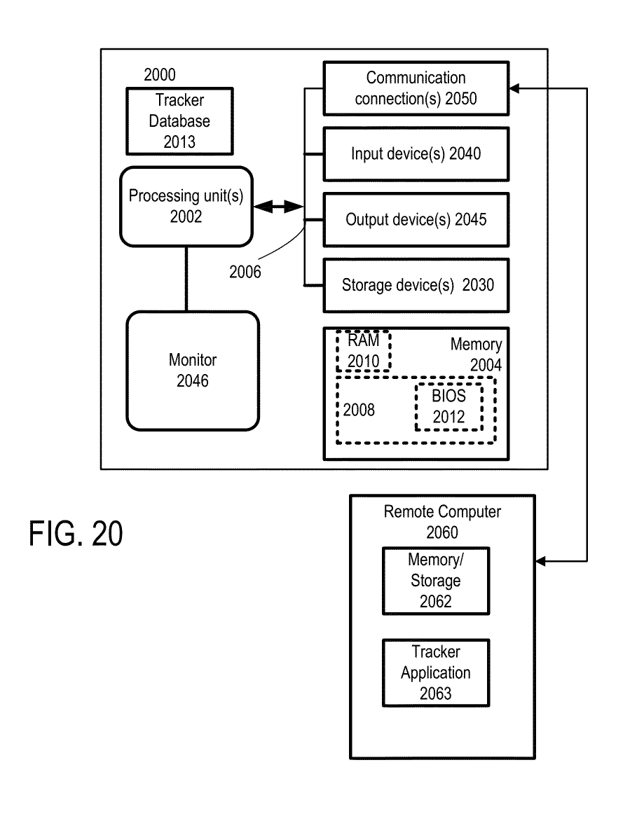

FIG. 20 and the following discussion are intended to provide a brief, general description of an exemplary computing environment in which the disclosed technology may be implemented. Although not required, the disclosed technology is described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 20, an exemplary system for implementing the disclosed technology includes a general purpose computing device in the form of an exemplary conventional PC 2000, including one or more processing units 2002, a system memory 2004, and a system bus 2006 that couples various system components including the system memory 2004 to the one or more processing units 2002. The system bus 2006 may be any of several types of bus structures including a memory bus or memory controller, a peripheral bus, and a local bus using any of a variety of bus architectures. The exemplary system memory 2004 includes read only memory (ROM) 2008 and random access memory (RAM) 2010. A basic input/output system (BIOS) 2012, containing the basic routines that help with the transfer of information between elements within the PC 2000, is stored in ROM 2008. A memory device 2013 stores asset tracker computer-executable instructions.

The exemplary PC 2000 further includes one or more storage devices 2030 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 2006 by a hard disk drive interface, a magnetic disk drive interface, and an optical drive interface, respectively. The drives and their associated computer-readable media provide nonvolatile storage of computer-readable instructions, data structures, program modules, and other data for the PC 2000. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored in the storage devices 2030 including an operating system, one or more application programs, other program modules, and program data. A user may enter commands and information into the PC 2000 through one or more input devices 2040 such as a keyboard and a pointing device such as a mouse. Other input devices may include a digital camera, microphone, joystick, game pad, satellite dish, scanner, or the like. These and other input devices are often connected to the one or more processing units 2002 through a serial port interface that is coupled to the system bus 2006, but may be connected by other interfaces such as a parallel port, game port, or universal serial bus (USB). A monitor 2046 or other type of display device is also connected to the system bus 2006 via an interface, such as a video adapter. Other peripheral output devices, such as speakers and printers (not shown), may be included.

The PC 2000 may operate in a networked environment using logical connections to one or more remote computers, such as a remote computer 2060. In some examples, one or more network or communication connections 2050 are included. The remote computer 2060 may be another PC, a server, a router, a network PC, or a peer device or other common network node, and typically includes many or all of the elements described above relative to the PC 2000, although only a memory storage device 2062 has been illustrated in FIG. 20. Data and computer executable instructions associated with asset tracking be stored in memory storage device 2063, the device 2062, or at a networked device. The personal computer 2000 and/or the remote computer 2060 can be connected to a logical a local area network (LAN) and a wide area network (WAN). Such networking environments are commonplace in offices, enterprise-wide computer networks, intranets, and the Internet.

When used in a LAN networking environment, the PC 2000 is connected to the LAN through a network interface. When used in a WAN networking environment, the

PC 2000 typically includes a modem or other means for establishing communications over the WAN, such as the Internet. In a networked environment, program modules depicted relative to the personal computer 2000, or portions thereof, may be stored in the remote memory storage device or other locations on the LAN or WAN. The network connections shown are exemplary, and other means of establishing a communications link between the computers may be used.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). As should be readily understood, the term computer-readable storage media does not include communication connections, such as modulated data signals. Any of the computer-executable instructions for implementing the disclosed techniques as well as any data created and used during implementation of the disclosed embodiments can be stored on one or more computer-readable media (e.g., non-transitory computer-readable media, which excludes propagated signals). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In view of the many possible embodiments to which the principles of the disclosed technology may be applied, it should be recognized that the illustrated embodiments are only preferred examples and should not be taken as limiting the scope of the technology. We claim as our invention all that comes within the scope and spirit of the appended claims.

1. An asset monitoring and recovery device, comprising:
a satellite receiver configured to receive satellite signals associated with asset location;
a cellular transceiver configured for communication in a cellular network;
at least one sensor configured to detect an asset disturbance corresponding to a change in asset location; and
a controller coupled to the satellite receiver, the cellular transceiver, and the at least one sensor and configured to supply a message for communication by the cellular transceiver, wherein the message is based on at least one of the asset disturbance and the received satellite signals.

2. The device of claim 1, wherein the at least one sensor is configured to detect the asset disturbance as an asset vibration, displacement, tilt, or temperature.

3. The device of claim 2, wherein the controller is configured to establish an asset event based on the asset disturbance, and the message includes an asset event report.

4. The device of claim 3, wherein the asset event is established based on a motion profile, and the asset event report indicates an asset vibration or displacement.

5. The device of claim 4, wherein the message is a text message, an email, or a push notification.

6. The device of claim 1, further comprising a proximity key receiver configured to detect a proximity key, wherein the proximity key receiver coupled to the controller so as to produce a disarm signal if a proximity key is detected.

7. The device of claim 1, further comprising an enclosure configured to be secured to a bicycle frame, and comprising an antenna configured to be secured to the frame exterior.

8. The device of claim 1, wherein the enclosure is configured to be situated within the bicycle frame.

9.-12. (canceled)

13. A mobile communication device, comprising:
a wireless transceiver configured to receive asset status information from a tagged asset; and
a display configured to provide asset status, wherein the status includes an indicator of an availability of a current location, and an indicator of asset security based on the current location with respect to at least one insecure location or based on the current location and at least one use pattern associated with the asset, the use pattern including asset use paths.

14. The mobile communication device of claim 13, wherein the asset status information includes asset identification information.

15. The mobile communication device of claim 14, wherein the asset identification information is an asset photograph or serial number.

16. The mobile communication device of claim 15, wherein the asset is a bicycle.

17. The mobile communication device of claim 13, wherein the transceiver is configured to communicate a request to arm or disarm an asset tracker.

18. The mobile communication device of claim 17, wherein the transceiver is configured to communicate asset tracker profile information associated with arming an asset tracker.

19. The mobile communication device of claim 18, wherein the asset tracker profile information includes an authorization to establish an armed asset tracker profile based on asset location, time of day, or asset disturbances.

20. The mobile communication device of claim 18, wherein the transceiver is configured to communicate an alarm request.

21. The mobile communication device of claim 20, wherein the transceiver is configured to receive notification of an asset disturbance or event, and the display is configured to indicate the asset disturbance or event.

22. (canceled)

23. The mobile communication device of claim 19, wherein the transceiver is configured to communicate a request to disarm the asset based on relative location of the mobile device and the asset.

24.-25. (canceled)

26. A method, comprising:
evaluating asset displacements of a tracked asset within a predetermined time period and a predetermined area;
based on the evaluation, indicating that the asset displacements outside of the predetermined time period and predetermined area are associated with unauthorized asset access; and
communicating the unauthorized asset access over a wireless communication network.

27.-28. (canceled)

29. The method of claim 26, further comprising communicating a request to notify law enforcement or a personal network, a social network, or a stolen bicycle registry of the unauthorized access.
